(19) United States
(12) Patent Application Publication
(10) Pub. No.: US 2026/0147446 A1
(43) Pub. Date: May 28, 2026

(54) INTERFACE INTERACTION

(71) Applicants: Beijing Zitiao Network Technology Co., Ltd., Beijing (CN); Lemon Inc., Grand Cayman (KY)

(72) Inventors: Baixuan Weng, Beijing (CN); Yuan Zhang, Beijing (CN); Ruoxi Wang, Culver City, CA (US); Weijian Chen, Beijing (CN); Peijun Guo, Beijing (CN)

(21) Appl. No.: 19/049,731

(22) Filed: Feb. 10, 2025

Related U.S. Application Data
(63) Continuation of application No. PCT/CN2024/133898, filed on Nov. 22, 2024.

(51) Int. Cl. G06F 3/0483; G06F 3/0484

(52) U.S. Cl. CPC G06F 3/0483; G06F 3/0484

(57) ABSTRACT

The embodiments of the disclosure provide a method, apparatus, device and computer-readable storage medium for interface interaction. The method includes: in response to a selection of a creation entry in an application, presenting a first tab page of a creation interface, the first tab page comprising a capture assembly; in response to receiving a first operation, presenting a second tab page of the creation interface, wherein the second tab page comprises at least a first region and a second region, the first region comprising at least an access entry of a media editor, and the second region presenting a set of media templates; and in response to a selection of the access entry, presenting an editing interface of the media editor of the application.

### CROSS-REFERENCE

The present application claims priority to International Application No. PCT/CN 2024/133898, filed on Nov. 22, 2024 and entitled “METHOD, APPARATUS, DEVICE AND STORAGE MEDIUM FOR INTERFACE INTERACTION”, the entirety of which is incorporated herein by reference.

### FIELD

Example embodiments of the present disclosure generally relate to the field of computers, and in particular, to interface interaction.

### BACKGROUND

With the development of computer technologies, artificial intelligence technologies are gradually applied to create various types of content. For example, for users with specialized knowledge, it can fine-grain edits the media content with a multi-track editor to generate high-quality media content. In addition, some users may also utilize an application-integrated media creation tool to quickly create media content without relying on mastery for the media editor.

### SUMMARY

In a first aspect of the present disclosure, a method of interface interaction is provided. The method comprises: in response to a selection of a creation entry in an application, presenting a first tab page of a creation interface, the first tab page comprising a capture assembly; in response to receiving a first operation, presenting a second tab page of the creation interface, where the second tab page comprises at least a first region and a second region, the first region comprising at least an access entry of a media editor, and the second region presenting a set of media templates; and in response to a selection of the access entry, presenting an editing interface of the media editor of the application.

In a second aspect of the present disclosure, an apparatus for interface interaction is provided. The apparatus comprises a first presenting module, a second presenting module and a third presenting module, where the first presenting module is configured to present, in response to a selection of an creation entry in an application, a first tab page of an creation interface the first tab page comprising a capture assembly; the second presenting module is to present, in response to receiving a first operation, a second tab page of the creation interface, where the second tab page comprises at least a first region and a second region, the first region comprising at least an access entry of a media editor, and the second region presenting a set of media templates; and the third presenting module is configured to present, in response to a selection of the access entry, an editing interface of the media editor of the application.

In a third aspect of the present disclosure, an electronic device is provided. The device comprises at least one processing unit; and at least one memory coupled to the at least one processing unit and storing instructions for execution by the at least one processing unit, the instructions upon execution by the at least one processing unit causing the electronic device to perform the method of the first aspect.

In a fourth aspect of the present disclosure, a computer-readable storage medium is provided. The computer-readable storage medium thereon storing a computer program, the computer program being executable by a processor to implement the method of the first aspect.

It should be understood that what is described in this content section is not intended to limit the key features or important features of the embodiments of the present disclosure, nor is it intended to limit the scope of the present disclosure. Other features of the present disclosure will become easily understandable from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numerals represent the same or similar elements, wherein:

FIG. 1 illustrates a schematic diagram of an example environment in which embodiments according to the present disclosure can be implemented;

FIGS. 2A-2D illustrate example interfaces according to some embodiments of the present disclosure;

FIG. 3 shows a flowchart of an example process of interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device in which various embodiments of the present disclosure can be implemented.

### DETAILED DESCRIPTION

Embodiments of the present disclosure will be described in more detail below with reference to the accompanying drawings. Although some embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, acquisition and/or use of data, and the like. These aspects all follow the corresponding laws and regulations and related regulations. In the embodiments of the present disclosure, the collecting, acquiring, handling, processing, forwarding, utilizing, etc. of all data are performed on the premise that the user knows and confirms. Accordingly, when implementing the embodiments of the present disclosure, the types the usage scope, the usage scenario, and the like of the data or information that may be involved, should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

As mentioned above, editing media content is an important way of interaction for interface interaction. For example, the user edits the media content by opening an editing interface of the media content in an interface associated with the camera function. In a conventional approach, the entry of the editing interface of the media content is presented in a different interface.

Embodiments of the present disclosure provide an interface interaction solution. The method comprises: in response to a selection of a creation entry in an application, presenting a first tab page of a creation interface, the first tab page comprising a capture assembly; in response to receiving a first operation, presenting a second tab page of the creation interface, where the second tab page comprises at least a first region and a second region, the first region comprising at least an access entry of a media editor, and the second region presenting a set of media templates; and in response to a selection of the access entry, presenting an editing interface of the media editor of the application.

In this way, embodiments of the present disclosure can provide a plurality of tab pages in a creation interface, thereby facilitating a user to quickly switch from a capture page of an application to an editing page of a media editor. Therefore, in the embodiment of the disclosure, more editing capability is provided for the condition of limited display screen region, the information corresponding to the editing capability is divided into clusters, the information efficiency is improved, the mistaken touch during user operation is avoided, the user interface interaction efficiency is improved, and the operation cost of the user is reduced.

Various example implementations of this scheme are described in detail below in conjunction with the accompanying drawings.

### Example Environment

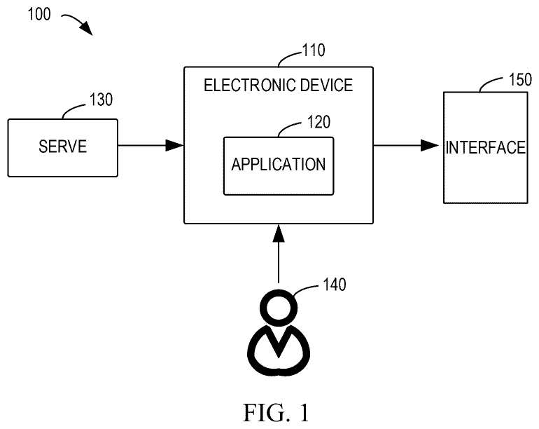

FIG. 1 illustrates a schematic diagram of an example environment 100 in which embodiments of the present disclosure can be implemented. As shown in FIG. 1, the example environment 100 may include an electronic device 110.

In this example environment 100, the electronic device 110 may run an application 120 for providing, viewing media content. The application 120 may be any suitable type of application for providing, viewing media content, examples of which may include, but are not limited to, online video applications or other appropriate applications that can provide online video services. The user 140 may interact with the application 120 via the electronic device 110 and/or its attachment device.

In the example environment 100 of FIG. 1, if the application 120 is active, the electronic device 110 may present the live interface 150 through the application 120.

In some embodiments, the electronic device 110 communicates with server 130 to enable provisioning of services to application 120. The electronic device 110 may be any type of mobile terminal, a fixed terminal, or a portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio streaming receiver, an electronic book device, a game device, or any combination thereof, including accessories and peripherals of these devices, or any combination thereof. In some embodiments, the electronic device 110 can also support any type of interface for a user (such as a “wearable” circuit, etc.) .

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide a background service for the application 120 that supports the virtual scene in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (WiFi) connection, and the like, and the embodiments of the present disclosure are not limited in this aspect. In an embodiment of the present disclosure, the server 130 and the electronic device 110 may implement signaling interaction by using a communication connection between the server 130 and the electronic device 110.

It should be understood that the structures and functions of the various elements in the example environment 100 are described for exemplary purposes only and do not imply any limitation to the scope of the present disclosure.

Some example embodiments of the present disclosure will be described below with continued reference to the accompanying drawings.

### Example Interaction

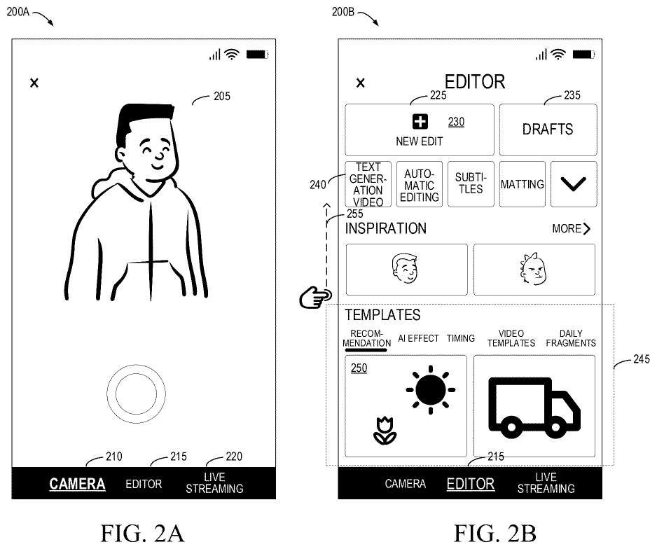

FIGS. 2A-2D illustrate example interfaces 200A-200D, according to some embodiments of the present disclosure. The interface 200A to the interface 200D may be provided, for example, by the electronic device 110 shown in FIG. 1.

FIG. 2A illustrates an example interface 200A, in accordance with some embodiments of the present disclosure. Interface 200A may, for example, apply the creation interface provided by the application 120. As an example, the electronic device 110 may receive a selection of a creation entry in the application 120 and may present a creation interface 200A as shown in FIG. 2A.

As shown, the creation interface 200A may include a plurality of tab pages, such as a tab page 210, a tab page 215, and a tab page 220. In some embodiments, as shown in FIG. 2A, the electronic device 110 may present the tab page 210, also referred to as a camera page. The tab page 201 may include, for example, a capture assembly 205 to support a user taking images by a camera of the electronic device 110.

Further, the electronic device 110 may receive a first operation of the user, and may switch to presenting the tab page 215 shown in FIG. 2B. As an example, the electronic device 110 may receive a left-sliding operation of the user in the tab page 210 and switch to presenting the tab page 215. As another example, the electronic device 110 may also receive a click of the user on the bottom tab bar and present the tab page 215.

As shown in FIG. 2B, the tab page 215 may include a plurality of regions, such as a first region 225 and a second region 245. The first region 225 may, for example, present an access entry 230 of a media editor of the application 120. The second region 245 may present one or more media templates 250 of the application 120.

In some embodiments, the electronic device 110 may receive a selection of the access entry 230 and may accordingly present an editing interface of the media editor in the application 120. In some embodiments, the media editor may include, for example, a multi-track editor to support users with expertise to edit media content through a multi-track editor.

Additionally, the electronic device 110 may also display the draft assembly 235 in the tab page 215 to display a preview of draft content associated with the media editor. As an example, the electronic device 110 may receive a selection of the draft assembly 235 and present draft content of the media editor.

In some embodiments, the electronic device 110 may also receive a selection of the media template 250 and may present a usage interface of the media template 250 to support the user to create new media content by utilizing the media template 250.

In this way, embodiments of the present disclosure can provide a plurality of tab pages in an creation interface, thereby facilitating a user to quickly switch from a capture page of an application to an editing page of a media editor. Therefore, the embodiment of the invention can improve the interaction efficiency of the user interface and reduce the operation cost of the user.

In some embodiments, as shown in FIG. 2B, the tab page further comprises a third region. The third region may present a set of access entries 240 corresponding to a set of creation tools in the application 120. In some embodiments, the set of creation tools correspond to different preset creation links in the application 120.

In some embodiments, such creation tools may correspond to, for example, a preset workflow in the application 120. For example, a user may use such creation tools to more quickly use the corresponding smart editing capabilities. As an example, such creation tools may include, but are not limited to, a text generation video tool, an automatic editing tool, a caption tool, and a matting tool, among others.

In some embodiments, the electronic device 110 may, for example, receive a user selection of the access entry 240 and may present a usage interface of a corresponding creation tool (e.g., a text generation video tool). Via the use interface, the electronic device 110 may support the user input text to automatically generate corresponding video content.

In this way, the embodiments of the present disclosure can also help the user to quickly obtain the creation tool in the application from the creation entry, thereby improving the efficiency of the user to create the media content.

In some embodiments, as shown in FIG. 2B, the electronic device 110 may further receive a second operation 255 for the tab page 215. As an example, the second operation 255 may include an up-sliding operation in the tab page 215.

Accordingly, the electronic device 110 may adjust the current display range of the tab page 215 based on the second operation 255. For example, the electronic device 110 may change the content displayed by the tab page 215 based on the up-slide operation. In some embodiments, the access entry 230 may be moved outside the current display range of the tab page 215 based on the second operation 255. Accordingly, as shown in FIG. 2C, the electronic device 110 may present the access entry 260 of the media editor at a first position of the tab page 215.

In some embodiments, the access entry 260 is outside of the current display range of the tab page 215, and the electronic device 110 may maintain at a position as shown in FIG. 2C to present the access entry 260 regardless of the change in the current display range. For example, if the electronic device 110 continues to receive the up-sliding operation 265 of the user, the electronic device 110 may only change the other display content in the tab page 215 and may display the access entry 260 at the original position.

In this way, embodiments of the present disclosure may help a user enter a media editor more quickly, thereby improving efficiency of media editing.

In some embodiments, as shown in FIG. 2C, the electronic device 110 may also display the access entry 260 in a preset region for displaying a page identifier (e.g., “editor” at the top) of the tab page 215.

As shown in FIGS. 2B and 2C, the access entry 230 and the access entry 260 have an associated display style. As an example, access entry 230 may include graphical element “+” and text element “new edit”. Correspondingly, the access entry 260 may also include graphical element “+” and text element “new edit”. In some embodiments, the display dimensions of the access entry 230 and the access entry 260 may be different, for example.

In some embodiments, in response to at least a portion of the access entry 230 moving outside the current display range, the electronic device 110 may also present a first animation associated with the access entry 230. Alternatively or additionally, the electronic device 110 may also present a second animation associated with the access entry 260. As an example, the first animation may include a change process of the transparency of the access entry 230 from high to low, and the second animation may include a change process of the transparency of the access entry 260 from low to high.

In some embodiments, the first animation and/or the second animation may also be associated with a progress of the access entry 230 moving outside the current display range. For example, if half of the region of the access entry 230 moves outside the current display range of the tab page, the first animation may cause the transparency of the access entry 230 to decrease to 50%, and the second animation may cause the transparency of the access entry 260 to rise to 50%.

Further, as shown in FIG. 2D, the second region 245 may further include a tab display region 270 and a template display region 275. Further, in response to the up-sliding operation 265 (also referred to as a second operation) for the tab page 215, the electronic device 110 may move the tab display region 270 to a second position, such as a top position, of the tab page 215.

Further, in response to the position of the template display region 275 satisfying a preset condition, the electronic device 110 may fix the tab display region 270 at the second position (e.g., the top position) of the tab page 215. Specifically, if the sliding operation is subsequently received, the electronic device 110 may determine whether the upper boundary of the template display region 270 is higher than the second position where the tab display region 270 is located. It should be understood that the upper boundary herein may refer to the position corresponding to the first template of the template list in the template display region 270, rather than the boundary of the display range of the template display region 270 in the current interface.

For example, if the sliding operation is an up-sliding operation, the electronic device 110 may keep the tab display region 270 ceiling displayed, and may change the template displayed in the template display region 275 accordingly.

For example, if the sliding operation is a down-sliding operation, the electronic device 110 may determine whether the upper boundary is higher than the second position. If so, the electronic device 110 may accordingly adjust the position of the tab display region 270 according to the down-sliding operation. Otherwise, the electronic device 110 may continue to keep the tab display region 270 ceiling displaying, and may change the template displayed in the template display region 275 accordingly.

As an example, the electronic device 110 may gradually switch from the state shown in FIG. 2D to the state shown in FIG. 2C as the down-sliding operation received in the tab page 215. Further, in the event to a continuous down-sliding to cause at least a portion of the access entry 230 being displayed, the electronic device 110 may display a disappearing animation (e.g., a fading process) of the access entry 260 until the state as shown in FIG. 2B.

In this way, the embodiments of the present disclosure can dynamically adjust the distribution of content in the tab page based on the user operation received in the tab page, and improve the efficiency of page interaction.

### Example Processes

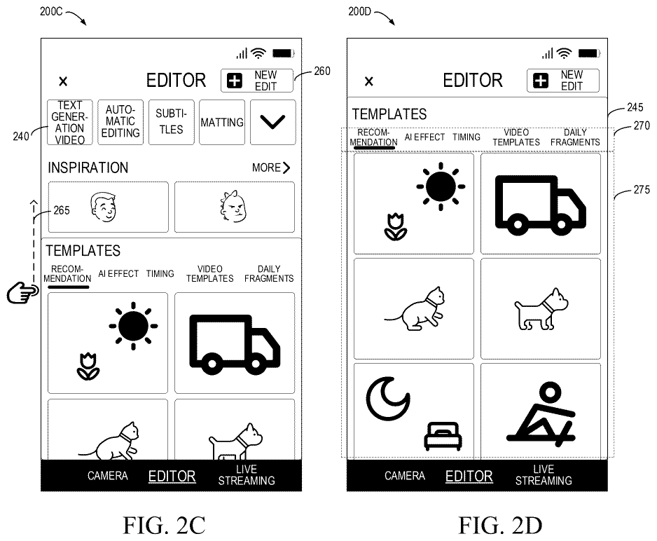

FIG. 3 illustrates a flowchart of an example process 300 of interface interaction in accordance with some embodiments of the present disclosure. Process 300 may be implemented at electronic device 110. The process 300 is described below with reference to FIG. 1.

As shown in FIG. 3, at block 310, the electronic device 110 presents a first tab page of the creation interface in response to a selection of a creation entry in the application, the first tab page comprising a capture assembly.

At block 320, the electronic device 110 presents, in response to receiving the first operation, a second tab page of the creation interface, the second tab page comprising at least a first region comprising at least an access entry of the media editor and a second region presenting a set of media templates.

At block 330, the electronic device 110 presents an editing interface of the media editor of the application in response to a selection of the access entry.

In some embodiments, the second tab page further comprises a third region presenting a set of access entries corresponding to a set of creation tools in the application, the set of creation tools corresponding to different creation links.

In some embodiments, the process 300 further comprises: in response to a selection of a target access entry of the set of access entries, presenting a usage interface corresponding to the target creation tool, the target creation tool corresponding to the target access entry.

In some embodiments, the access entry is a first access entry, the process 300 further comprising: adjusting a current display range of the second tab page based on a second operation on the second tab page; and presenting a second access entry of the media editor at a first position of the second tab page in response to the first access entry moving outside the current display range.

In some embodiments, the process 300 further comprises, in response to the first access entry being outside the current display range, maintaining the presentation of the second access entry at the first position regardless of the change in the current display range.

In some embodiments, the second tab page comprises a preset region for displaying the page identifier of the second tab page, and presenting the second access entry of the media editor at the first position of the second tab page comprises presenting the second access entry of the media editor at the first position in the preset region.

In some embodiments, the first access entry and the second access entry have an associated display style.

In some embodiments, the process 300 further comprises presenting a first animation associated with the first access entry and/or a second animation associated with the second access entry in response to at least a portion of the first access entry moving outside the current display range.

In some embodiments, the first animation and/or the second animation is associated with a progress of the first access entry moving outside the current display range.

In some embodiments, the second region comprises a tab display region and a template display region, and the method further comprises: moving the tab display region to a second position of the tab page based on a second operation on the second tab page; receiving a third operation for the second tab; and in response to the position of the template display region satisfying a preset condition, fixing the tab display region at the second position of the current display region.

### Example Apparatus and Apparatus

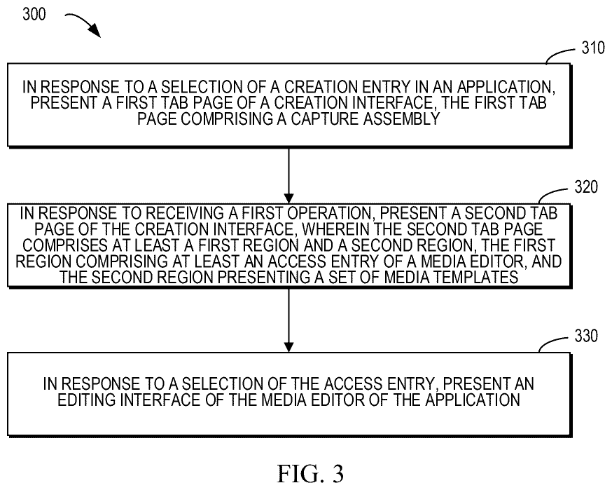

Embodiments of the present disclosure also provide a corresponding apparatus for implementing the above method or process. FIG. 4 illustrates a schematic structural block diagram of an example apparatus 400 for interface interaction according to some embodiments of the present disclosure. The apparatus 400 may be implemented or included in the electronic device 110. The various modules/assemblies in the apparatus 400 may be implemented by hardware, software, firmware, or any combination thereof.

As shown in FIG. 4, the apparatus 400 comprises: a first presenting module 410, configured to present, in response to a selection of an creation entry in an application, a first tab page of an creation interface, the first tab page comprising a capture assembly; a second presenting module 420, configured to present, in response to receiving a first operation, a second tab page of the creation interface. The second tab page comprises at least a first region and a second region, the first region comprising at least an access entry of the media editor, and the second region presenting a set of media templates; and a third presenting module 430 configured to present, in response to a selection of the access entry, an editing interface of the media editor of the application.

In some embodiments, the second tab page further comprises a third region presenting a set of access entries corresponding to a set of creation tools in the application, the set of creation tools corresponding to different creation links.

In some embodiments, the apparatus 400 further comprises an creation interface presenting module configured to in response to a selection of a target access entry of the set of access entries, present a usage interface corresponding to a target creation tool, the target creation tool corresponding to the target access entry.

In some embodiments, the access entry is a first access entry, the apparatus 400 further comprises an adjustment module configured to adjust a current display range of the second tab page based on a second operation on the second tab page; and present a second access entry of the media editor at a first position of the second tab page in response to the first access entry moving outside the current display range.

In some embodiments, the apparatus 400 further comprises a second access entry presenting module configured to, in response to the first access entry being outside of the current display range, maintain presenting the second access entry at the first position regardless of the change in the current display range.

In some embodiments, the second tab page comprises a preset region for displaying the page identifier of the second tab page, and presenting the second access entry of the media editor at the first position of the second tab page comprises presenting the second access entry of the media editor at the first position in the preset region.

In some embodiments, the first access entry and the second access entry have an associated display style.

In some embodiments, the apparatus 400 further comprises a second animation presenting module configured to present a first animation associated with the first access entry and/or a second animation associated with the second access entry in response to at least a portion of the first access entry moving outside the current display range.

In some embodiments, the first animation and/or the second animation is associated with a progress of the first access entry moving outside the current display range.

In some embodiments, the second region comprises a tab display region and a template display region, and the apparatus 400 further comprises a moving module configured to move the tab display region to a second position of the tab page based on a second operation on the second tab page; receive a third operation for the second tab; and in response to the position of the template display region satisfying a preset condition, fix the tab display region at the second position of the current display region.

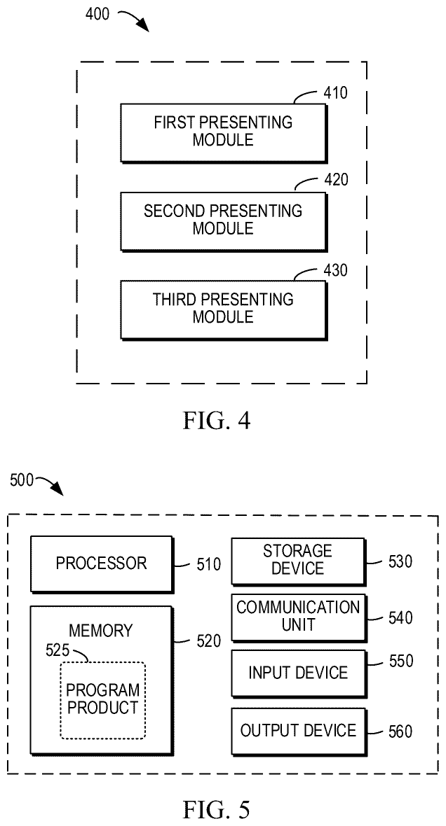

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines, these computing machines are capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable storage medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart and/or block diagram. These computer-readable program instructions may also be stored in a computer-readable medium that cause the computer, programmable data processing apparatus, and/or other devices to function in a particular manner, such that the computer-readable storage medium storing instructions includes an article of manufacture including instructions to implement aspects of the functions/acts specified in one or more blocks in the flowchart and/or block diagram.

The computer-readable program instructions may be loaded onto a computer, other programmable data processing apparatus, or other device, such that a series of operational steps are performed on a computer, other programmable data processing apparatus, or other device to produce a computer-implemented process such that the instructions executed on a computer, other programmable data processing apparatus, or other device implement the functions/acts specified in one or more blocks in the flowchart and/or block diagram.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method of interface interaction, comprising:
in response to a selection of a creation entry in an application, presenting a first tab page of a creation interface, the first tab page comprising a capture assembly;
in response to receiving a first operation, presenting a second tab page of the creation interface, wherein the second tab page comprises at least a first region and a second region, the first region comprising at least an access entry of a media editor, and the second region presenting a set of media templates; and
in response to a selection of the access entry, presenting an editing interface of the media editor of the application.

2. The method of claim 1, wherein the second tab page further comprises a third region presenting a set of access entries corresponding to a set of creation tools in the application, the set of creation tools corresponding to different creation links.

3. The method of claim 2, further comprising:
in response to a selection of a target access entry of the set of access entries, presenting a usage interface corresponding to a target creation tool, the target creation tool corresponding to the target access entry.

4. The method of claim 1, wherein the access entry is a first access entry, the method further comprising:
adjusting a current display range of the second tab page based on a second operation on the second tab page; and
in response to the first access entry moving outside the current display range, presenting a second access entry of the media editor at a first position of the second tab page.

5. The method of claim 4, further comprising:
in response to the first access entry being outside of the current display range, maintaining the second access entry at the first position regardless of a change of the current display range.

6. The method of claim 4, wherein the second tab page comprises a preset region for displaying a page identifier of the second tab page, and presenting the second access entry of the media editor at the first position of the second tab page comprises:
presenting the second access entry of the media editor at the first position in the preset region.

7. The method of claim 4, wherein the first access entry and the second access entry have an associated display style.

8. The method of claim 4, further comprising:
in response to at least a portion of the first access entry moving outside the current display range, presenting a first animation associated with the first access entry and/or a second animation associated with the second access entry.

9. The method of claim 8, wherein the first animation and/or the second animation is associated with a progress of the first access entry moving outside the current display range.

10. The method according to claim 4, wherein the second region comprises a tab display region and a template display region, and the method further comprises:
moving the tab display region to a second position of the tab page based on the second operation on the second tab page;
receiving a third operation for the second tab; and
fixing the label display region in the second position of the current display region in response to the position of the template display region satisfying a preset condition.

11. An electronic device, comprising:
at least one processing unit; and
at least one memory coupled to the at least one processing unit and storing instructions for execution by the at least one processing unit, the instructions upon execution by the at least one processing unit causing the electronic device to perform operations comprising:
in response to a selection of a creation entry in an application, presenting a first tab page of a creation interface, the first tab page comprising a capture assembly;
in response to receiving a first operation, presenting a second tab page of the creation interface, wherein the second tab page comprises at least a first region and a second region, the first region comprising at least an access entry of a media editor, and the second region presenting a set of media templates; and
in response to a selection of the access entry, presenting an editing interface of the media editor of the application.

12. The device of claim 11, wherein the second tab page further comprises a third region presenting a set of access entries corresponding to a set of creation tools in the application, the set of creation tools corresponding to different creation links.

13. The device of claim 12, wherein the operations further comprise:
in response to a selection of a target access entry of the set of access entries, presenting a usage interface corresponding to a target creation tool, the target creation tool corresponding to the target access entry.

14. The device of claim 11, wherein the access entry is a first access entry, the method further comprising:
adjusting a current display range of the second tab page based on a second operation on the second tab page; and
in response to the first access entry moving outside the current display range, presenting a second access entry of the media editor at a first position of the second tab page.

15. The device of claim 14, wherein the operations further comprise:
in response to the first access entry being outside of the current display range, maintaining the second access entry at the first position regardless of a change of the current display range.

16. The device of claim 14, wherein the second tab page comprises a preset region for displaying a page identifier of the second tab page, and presenting the second access entry of the media editor at the first position of the second tab page comprises:
presenting the second access entry of the media editor at the first position in the preset region.

17. The device of claim 14, wherein the first access entry and the second access entry have an associated display style.

18. The device of claim 14, wherein the operations further comprise:
in response to at least a portion of the first access entry moving outside the current display range, presenting a first animation associated with the first access entry and/or a second animation associated with the second access entry.

19. The device of claim 18, wherein the first animation and/or the second animation is associated with a progress of the first access entry moving outside the current display range.

20. A non-transitory computer-readable storage medium thereon storing a computer program, the computer program being executable by a processor to implement operations comprising:
in response to a selection of a creation entry in an application, presenting a first tab page of a creation interface, the first tab page comprising a capture assembly;
in response to receiving a first operation, presenting a second tab page of the creation interface, wherein the second tab page comprises at least a first region and a second region, the first region comprising at least an access entry of a media editor, and the second region presenting a set of media templates; and
in response to a selection of the access entry, presenting an editing interface of the media editor of the application.
